(19) United States
(12) Patent Application Publication
(10) Pub. No.: US 2026/0070232 A1
(43) Pub. Date: Mar. 12, 2026

(54) MAGNETIC GRIPPER AND MAGNETIC GRIPPER SYSTEM

(71) Applicant: J.Schmalz GmbH, Glatten (DE)

(72) Inventors: Michael STORZ, Empfingen (DE); Johannes Clauß, Neubulach (DE)

(73) Assignee: J.Schmalz GmbH, Glatten (DE)

(21) Appl. No.: 19/318,450

(22) Filed: Sep. 4, 2025

(30) Foreign Application Priority Data
Sep. 9, 2024 (DE) 10 2024 125 824.1

(51) Int. Cl. B25J 15/06

(52) U.S. Cl. CPC B25J 15/0608

(57) ABSTRACT

A magnetic gripper for gripping a ferromagnetic workpiece, having: a housing; a magnet arranged in the housing and displaceable along a displacement direction between a gripping position for gripping the ferromagnetic workpiece and a release position for releasing the ferromagnetic workpiece; and a number of pole shoes fastened to the housing. Each pole shoe has a workpiece contact surface and is designed to guide a magnetic field portion of the magnet to the workpiece contact surface. Each workpiece contact surface defines a contact surface angle between itself and the displacement direction. The contact surface angle ranges in size from 170° to 190°.

### DESCRIPTION

The invention relates to a magnetic gripper and a magnetic gripper system.

Known magnetic grippers have a magnet, often a permanent magnet, for generating a magnetic field for gripping ferromagnetic workpieces, and pole shoes are used to guide a portion of the magnetic field to the workpiece to be gripped.

DE 20 2019 005 976 U1 discloses a magnetic gripper with a permanent magnet. The permanent magnet is movable along a vertical axis between a lowered position and a raised position. The magnetic gripper has two pole shoes, each with a workpiece contact surface for contacting a ferromagnetic workpiece to be gripped. When the permanent magnet is in the lowered position and the workpiece contact surfaces of the pole shoes contact the workpiece to be gripped, the workpiece to be gripped is subjected to a magnetic force and pressed against the workpiece contact surfaces. Each workpiece contact surface is aligned orthogonally with respect to the vertical axis or the movement axis of the magnet. In this respect, such magnetic grippers are usually positioned vertically during operation and therefore require a lot of space in the vertical direction.

The object of the invention is to allow a secure gripping of a ferromagnetic workpiece even with non-vertical gripping geometries or limited space and/or to perform special gripping tasks, such as the gripping of metal sheets.

The invention achieves this object by a magnetic gripper having the features of claim 1 and by a magnetic gripper system having the features of claim 14. Advantageous embodiments and developments of the invention emerge from the dependent claims.

A magnetic gripper according to the invention is configured to grip a ferromagnetic workpiece. The magnetic gripper has a housing, a magnet, and a number of pole shoes—for example, 1, 2, or 3. The magnet is arranged in the housing and can be displaced between a gripping position for gripping the ferromagnetic workpiece and a release position for releasing the ferromagnetic workpiece along a displacement direction or displacement axis that is, in particular, straight. The number of pole shoes are attached to the housing. Each pole shoe has a workpiece contact surface and is designed to guide, in particular direct, a portion of the magnetic field of the magnet to the workpiece contact surface. Each of the workpiece contact surfaces is aligned at least substantially parallel to the displacement direction, i.e., defines between itself and the displacement direction or displacement axis a contact surface angle which ranges in size from 170°to 190°. In particular, the workpiece contact surfaces are aligned parallel to the displacement direction.

Advantageously, by aligning the workpiece contact surface of each pole shoe with the contact surface angle with respect to the displacement direction, a height, in particular a maximum overall height, of the magnetic gripper, which is measurable in a direction orthogonal to the workpiece contact surface, can be reduced. Due to the reduced height of the magnetic gripper, a processing machine (e.g., press machine, transfer press, punching machine) only needs to open its respective tools with a shorter stroke in order to insert the workpiece using the magnetic gripper or to remove the processed workpiece. By reducing the stroke, the time required to open the tool can be reduced, which is why a number of workpieces can be processed one after the other in a shorter period of time using the press machine or punching machine. Therefore, the magnetic gripper can be used to increase the throughput and cycle time of the press machine or punching machine and reduce the unit costs for machining a workpiece.

Another aspect of the magnetic gripper can be that, after inserting the workpiece into the press machine or punching machine and after releasing the workpiece from the magnetic gripper, the magnetic gripper only needs to be moved slightly away from the workpiece in order to remove the magnetic gripper from a working region of the press machine or punching machine. Therefore, the stroke can be slightly, e.g., 2% or 1%, more than the sum of the height of the magnetic gripper and the thickness of the workpiece. Therefore, the pressing machine or punching machine can be opened with a particularly small stroke.

According to one aspect of the invention, the magnetic gripper can be based upon the principle that a distance along a straight line orthogonal to the workpiece contact surface between the workpiece contact surface and the magnet in the gripping position and a distance along the straight line orthogonal to the workpiece contact surface between the workpiece contact surface and the magnet in the release position are equal in size.

The ferromagnetic workpiece can be made of iron or steel. The workpiece can be a metal sheet or a plate. In particular, a width and/or a length of the workpiece can be more than five times, in particular ten times, a thickness of the workpiece. The thickness of the workpiece can, for example, range in size from 0.5 mm (millimeters) to 5 cm (centimeters), in particular 0.5 mm to 5 mm.

Gripping the workpiece can be understood as the magnetic field portion guided by the number of pole shoes being coupled into the workpiece in such a way that the workpiece experiences a magnetic force due to the coupled magnetic field portion, which presses the workpiece against the pole shoes. The magnetic force is then in particular greater than the weight of the workpiece. In other words, the ferromagnetic workpiece can be gripped by the magnetic gripper if the magnetic field portion guided by the number of pole shoes pushes or presses the workpiece against the workpiece contact surface. The workpiece contact surface can also be referred to as the workpiece bearing surface.

The housing can be formed in one piece or have a plurality of housing parts which, when assembled, form the housing. The housing can be non-magnetizable. The housing can be made of a non-ferromagnetic material such as aluminum. The housing can have an interior space in which the magnet is arranged.

The magnet can be carried by the housing. The magnet serves to generate a magnetic field, wherein at least a portion of the magnetic field is conducted through the pole shoes. The magnet can be a permanent magnet and/or an electromagnet. In particular, the design of the magnet as a permanent magnet can allow safe and reliable gripping of the workpiece, because the workpiece continues to be gripped safely and reliably in the event of a power failure.

Preferably, the magnetic gripper can have a single pole shoe or two pole shoes. If the magnetic gripper has two pole shoes, these can be attached to the housing on opposite sides of the housing. In other words, if the magnetic gripper has two pole shoes, the housing can be located between the two pole shoes.

Each pole shoe can be detachably attached to the housing, in particular by means of a screw connection. This means that each pole shoe can be replaced. For example, a defective pole shoe can be replaced with a functioning pole shoe, which simplifies repair of the magnetic gripper. Furthermore, for example, exchanging the number of pole shoes allows the magnetic gripper to be adapted to the workpiece to be gripped. This can be done by attaching pole shoes to the housing that are optimal for gripping the workpiece. Advantageously, this makes it possible for the magnetic gripper to be adapted to different workpieces, thereby increasing the possible applications of the magnetic gripper.

The magnetic gripper may have a fastening device for fastening the pole shoe to the housing. The fastening device can have at least one through hole in each pole shoe for receiving a fastening screw for establishing a screw connection between the pole shoe and the housing of the magnetic gripper. The through hole can be designed as a countersunk hole. Additionally or alternatively, the fastening device may have at least one thread in the housing or in each pole shoe for establishing the screw connection between the pole shoe and the housing of the magnetic gripper.

Each pole shoe can be made of a material that has the property of amplifying and/or conducting magnetic fields. Each pole shoe can be made of a ferromagnetic material, in particular iron, steel, nickel, or cobalt.

Each pole shoe is advantageously constructed in one piece. However, multi-part designs are also possible-for example, to simplify the assembly of the magnetic gripper.

Directing or guiding the magnetic field portion of the magnet to the workpiece contact surface can be understood as meaning that a portion of the magnetic field of the magnet is deflected, reshaped, and/or concentrated in certain regions by, and/or by means of, the pole shoe. In particular, when the magnet is in the gripping position, the magnetic field portion guided by the number of pole shoes can be a required or desired portion of the magnetic field for gripping the workpiece. The magnetic field portion can be guided by the number of pole shoes if a magnetic field line of the magnetic field runs within the number of pole shoes and exits the workpiece contact surface.

The magnet can have a north pole and a south pole. The magnetic field of the magnet can extend from the north pole to the south pole.

The magnet can be moved between the gripping position and the release position by a translational movement. The translational movement can be a straight movement, in particular a vertical movement. In other words, the direction of displacement can be straight. For example, the magnet can be transferred between the gripping position and the release position by a linear displacement of the magnet along the displacement direction. The term displacement axis or movement axis can be used alternatively to the term displacement direction.

For example, the magnet can be moved from the release position to the gripping position by a movement along the displacement direction and from the gripping position to the release position by a movement opposite the displacement direction. Alternatively, the magnet can be moved from the release position to the gripping position by a movement opposite the displacement direction and from the gripping position to the release position by a movement along the displacement direction.

The magnet can be linearly displaceable in the housing, in particular along a straight trajectory. The magnet can be moved from the release position to the gripping position by moving the magnet to the number of pole shoes. Moving the magnet from the gripping position to the release position can be done by moving the magnet away from the number of pole shoes. In other words, an extent of a distance between the number of pole shoes and the magnet in the gripping position may be smaller than an extent of a distance between the number of pole shoes and the magnet in the release position. As a result, when the magnet is in the gripping position, a magnetic field portion that is directed to the workpiece contact surface of each pole shoe can be larger than a magnetic field portion that is directed to the workpiece contact surface of each pole shoe when the magnet is in the release position.

When the magnet is in the gripping position, the magnetic gripper can be designed to grip the workpiece. When the magnet is in the release position, the magnetic gripper can be designed not to grip the workpiece. A distance between a workpiece arranged on the workpiece contact surfaces and the magnet in the gripping position may be smaller than a distance between the workpiece arranged on the workpiece contact surfaces and the magnet in the release position.

The workpiece contact surfaces can be aligned parallel to one another. All workpiece contact surfaces can be arranged in one plane. The workpiece contact surfaces can form a holding surface, in particular a flat one, of the magnetic gripper.

Each contact surface angle can range in size from 185° to 185°. Preferably, each contact surface angle can be 180°. When each contact surface angle is 180°, each workpiece contact surface may be aligned parallel to the displacement direction, in particular, each workpiece contact surface may extend parallel to the displacement direction.

The workpiece contact surface of each pole shoe can be designed to make contact with the ferromagnetic workpiece.

The workpiece contact surface of each pole shoe can be flat. This can be useful because, for workpieces with typical proportions, the contact region for the pole shoe is often at least approximately flat. A flat workpiece contact surface is also often useful for unstacking a stack of several magnetic metal sheets or the like. An uneven, e.g., curved, workpiece contact surface can, however, be useful if the workpiece is to be contacted in a correspondingly uneven, e.g., curved, area. Consequently, the workpiece contact surface of each pole shoe can be flat or curved, in particular convex, depending upon the application. The desired, largely parallel alignment of the workpiece contact surface to the displacement direction can then be defined such that the mean or average surface normal of the workpiece contact surface forms the aforementioned contact surface angle with the displacement direction or, in particular, is orthogonal to the displacement direction.

Unstacking can be understood as gripping the top workpiece of a stack, in particular a stack of workpieces, without gripping the second from the top workpiece.

The workpiece contact surface of each pole shoe can be formed as an uninterrupted surface. This allows the holding force that occurs when gripping a workpiece to be distributed evenly over a larger area. Therefore, a more even pressure distribution on the workpiece can be achieved, which better protects the workpiece from deformation or damage.

The formation of the workpiece contact surface as an uninterrupted surface can be understood as meaning that any two points on the workpiece contact surface can be connected to one another by a continuous curve, line, or path without leaving the workpiece contact surface. In other words, the continuous curve, line, or path can be within the workpiece contact surface.

The uninterrupted surface can be called a continuous surface. In particular, the uninterrupted surface can be formed without holes and/or without interruptions.

Another aspect of the magnetic gripper can be that the workpiece contact surface is designed to make contact across boreholes in the workpiece. This can simplify the positioning of a point on the workpiece at which the magnetic gripper grips the workpiece.

In a further development of the magnetic gripper, the housing extends along a longitudinal axis. The displacement direction is parallel to the longitudinal axis. Advantageously, the elongated housing allows the magnetic gripper to be designed compactly.

In a further development of the magnetic gripper, each pole shoe has an active structure for directing the magnetic field portion, in particular to the workpiece contact surface.

By directing the magnetic field portion using the active structure, the depth effect of the magnetic field portion on the workpiece can be reduced. In particular, the active structure can reduce the depth effect of the magnetic field portion on the workpiece in that the active structure directs the magnetic field portion in such a way that a distance of the magnetic field lines of the magnetic field portion, after the magnetic field portion comes out of the workpiece contact surface, from the workpiece contact surface is smaller than a distance of the magnetic field lines of the magnetic field portion, after the magnetic field portion comes out of the workpiece contact surface, from the workpiece contact surface without the active structure. By reducing the depth effect, unstacking, in particular of thin workpieces, can be made easier.

The directing of the magnetic field portion by means of the active structure can comprise at least partial focusing. By focusing the magnetic field portion, the holding force of the magnetic gripper can be increased.

The effective structure can be formed by a geometric design of the pole shoe for the targeted directing of the magnetic field lines. The geometric design may have at least one bevel and/or at least one rounding. The geometric design can be created by incorporating shoulders, boreholes, recesses, and/or steps.

The active structure can be formed by a material accumulation and/or a material reduction. The active structure can be formed by a geometric shape and/or by a microstructure of the pole shoe. The active structure may, for example, have a number of channels, a number of slits, a number of depressions, and/or a number of elevations. The active structure can be designed as a periodic structure.

The active structure can be designed to deflect the magnetic field by 90°.

In a further development of the magnetic gripper, the active structure has a bevel. The bevel, in particular a flat surface of the bevel, and the workpiece contact surface define a bevel angle between them. The bevel angle ranges in size from 5° to 85°, in particular 15° to 75°, preferably 40° to 60°. Advantageously, the bevel can increase the magnetic field portion at the workpiece contact surface.

The slope can be called a bevel. In particular, the bevel can cause a corner of the pole shoe to be beveled. The bevel and the workpiece contact surface can be spatially separated from one another. The bevel and the workpiece contact surface cannot be arranged next to one another, especially directly.

The bevel can be formed by the flat surface. The flat surface cannot be aligned parallel or orthogonal to the longitudinal axis of the housing. The flat surface can face away from the workpiece contact surface.

In a further development of the magnetic gripper, the active structure has a plurality, e.g., 2, 3, or 4, of projections for directing the magnetic field portion and for forming the workpiece contact surface. Advantageously, the projections can be easy to manufacture.

Each projection can have a free end that partially forms the workpiece contact surface. A cross-sectional area of the projection may have a constant area with increasing distance from the housing to its free end. Alternatively, a cross-sectional area of the projection may have a decreasing surface area with increasing distance from the housing.

Two adjacent projections can be separated from one another by a recess. The recess can be called a cutout. The plurality of projections of each pole shoe can together form the workpiece contact surface. In particular, each projection may have a surface portion that forms a portion of the workpiece contact surface. The surface portions of the plurality of projections may form the workpiece contact surface. The free end of each projection may be formed by the surface portion. The surface portion can be a flat surface portion.

In particular, the number of projections may be 2, 3, or 4. With such a number of projections, a particularly safe and reliable gripping of the workpiece can be achieved. With a higher number of projections, the additional projections may be far enough away from the magnet in the gripping position that they do not make gripping the workpiece any safer or more reliable. Therefore, each active structure cannot have more than four projections.

In a further development of the magnetic gripper, the plurality of projections has at least a first projection and a second projection. The first projection and the second projection are arranged adjacent to one another. The first projection is separated from the second projection by a recess, in particular a cutout. A depth and/or a length of the recess has a value that deviates by at most 25%, in particular 10%, 5%, or 1%, from a value of a length of the first projection and/or from a value of a length of the second projection. This can advantageously achieve a reduction in the depth effect for unstacking thin workpieces.

Preferably, the length of the recess may have a value that deviates by at most 25% from the value of the length of the first projection and/or from the value of the length of the second projection. A length of the first projection and a length of the second projection may be of equal size.

The depth and/or the length of the recess may have a value that is equal to a value of the length of the first projection and/or that is equal to a value of the length of the second projection.

In a further development of the magnetic gripper, the magnetic gripper has a positioning device for positioning the workpiece on the workpiece contact surfaces of the number of pole shoes. Advantageously, this ensures that the workpiece is positioned in a defined position on the workpiece contact surfaces.

The positioning device can be adjacent to the workpiece contact surface. The positioning device may have a stop and/or guide-for example, in the form of a surface. The guide can be designed to guide the workpiece to the workpiece contact surface. The stop can limit movement of the workpiece when the workpiece is arranged on the workpiece contact surfaces.

For example, the workpiece contact surface can be brought close to the workpiece, and the magnet can be moved into the gripping position. This allows the magnet's magnetic field to act upon the workpiece. The resulting magnetic force can press the workpiece against the guide of the positioning device so that the workpiece slides along the guide and thereby guides the workpiece to the workpiece contact surfaces until the workpiece lies flat against the workpiece contact surfaces.

The housing and/or the number of pole shoes may include the positioning device. For example, the positioning device can be formed by a surface portion of the pole shoes and another surface portion of the housing. In particular, each pole shoe may have a surface portion for forming the positioning device.

In a further development of the magnetic gripper, the number of pole shoes includes a first pole shoe and a second pole shoe. The magnet is arranged in the housing in such a way that, in the gripping position, the first pole shoe acts as the north pole and the second pole shoe acts as the south pole. Advantageously, the two pole shoes allow efficient use of the magnetic field portion, which is why the magnetic gripper can grip the workpiece particularly safely and reliably.

The magnet can be arranged in the housing such that, in the gripping position, the north pole is directed toward the first pole shoe and the south pole is directed toward the second pole shoe.

In a further development of the magnetic gripper, the magnet can be moved electrically, pneumatically, or mechanically between the gripping position and the release position. Advantageously, the magnetic gripper can be manufactured with a small number of components.

The magnetic gripper may include an actuator for moving the magnet between the gripping position and the release position. The actuator may be configured to drive the displacement of the magnet. The actuator can have an electric motor for electrical displacement, a lever for mechanical displacement, or a pneumatic drive for pneumatic displacement of the magnet.

Preferably, the magnet can be pneumatically displaceable, and the actuator can have a pneumatic piston which is connected to the magnet, in particular directly. The housing can have a pneumatic cylinder in which the pneumatic piston is arranged, in particular in a displaceable manner.

In a further development of the magnetic gripper, the magnetic gripper has a position sensor for detecting the gripping position and/or the release position. Additionally or alternatively, the magnetic gripper has a workpiece sensor for detecting the workpiece.

The workpiece sensor can be designed to detect whether the workpiece is located on the workpiece contact surfaces of the pole shoes, in particular whether it is in contact. The workpiece sensor can have a mechanical probe, an optical sensor, and/or an inductive sensor, in particular a magnetic field sensor, preferably a Hall sensor.

The workpiece sensor can be designed to detect a thickness of the workpiece and/or a material located beneath the workpiece. The workpiece sensor can be designed to release and/or prevent the displacement of the magnet between the gripping position and the release position depending upon the detected thickness of the workpiece and/or the detected material located under the workpiece. This allows a stack of workpieces to be reliably unstacked, especially separated. This also allows for quality control of the workpiece. For example, the magnetic gripper can grip only workpieces whose thickness is within a specified range.

The position sensor can be designed to detect whether a displacement of the magnet from the gripping position to the release position and/or from the release position to the gripping position has been successfully completed. The position sensor can have a mechanical button, an optical sensor, and/or an inductive sensor, in particular a magnetic field sensor, preferably a Hall sensor.

In a further development of the magnetic gripper, the housing has a receptacle, in particular in the form of a groove, for receiving the workpiece sensor and/or a supply line. Advantageously, the workpiece sensor and/or the supply line can be positioned at a defined position by means of the groove.

The receptacle may extend parallel to the longitudinal axis of the housing and/or parallel to the displacement direction. The receptacle can be open on a side of the magnetic gripper which has the workpiece contact surfaces. This allows the workpiece sensor to face directly toward a workpiece gripped with the magnetic gripper, thereby improving the detection result of the workpiece sensor.

The receptacle may have a T-shaped cross-section. Advantageously, the T-shaped cross-section can simplify the attachment of the workpiece sensor and/or the supply line to the housing.

In a further development of the magnetic gripper, the magnetic gripper has a magnetic gripper interface for attaching the magnetic gripper to a manipulator. This makes it particularly easy and quick to connect the magnetic gripper to the manipulator.

The manipulator interface can be designed for tool-free attachment of the magnetic gripper to the manipulator and/or for tool-free detachment of the magnetic gripper from the manipulator. The manipulator interface can have a quick-connect coupling-for example, in the form of a bayonet lock.

The manipulator can, for example, be a robot or robot arm. The manipulator interface can be arranged on the housing. The manipulator interface can form a free end of the magnetic gripper.

The manipulator interface and the housing can be electrically insulated from one another. This can prevent electrical current from passing from the workpiece to the manipulator or from the manipulator to the workpiece. This can protect the press machine or punching machine that processes the workpiece and the manipulator from damage caused by electrical current.

The manipulator interface can be spherical. The manipulator interface can be a ball of a ball joint. The manipulator interface may be designed to be attached to the manipulator to form a ball joint. Advantageously, the ball joint allows for a high degree of freedom of movement while simultaneously allowing easy positioning of the magnetic gripper relative to the manipulator.

In a further development of the magnetic gripper, a housing portion of the housing is designed to prevent the magnetic field of the magnet from escaping the housing portion, in particular when the magnet is in the release position. Additionally or alternatively, the magnetic gripper has a shielding device which is designed to at least partially prevent the magnetic field of the magnet from escaping the housing, in particular when the magnet is in the release position. Advantageously, this can prevent an unwanted magnetic force from acting upon the workpiece or upon other ferromagnetic objects placed near the magnetic gripper.

Preferably, in the release position, the magnet can be at least partially surrounded by the housing portion, which prevents the magnetic field from escaping, and/or the shielding device. The housing portion can be made of a ferromagnetic material, in particular iron or steel. The housing portion can be circular or hollow-cylindrical in shape.

The shielding device may be formed from a ferromagnetic material, in particular iron or steel. The shielding device can be circular or hollow-cylindrical in shape.

Advantageously, when the magnet is moved into the release position, the magnetic field of the magnet can act upon the housing portion that prevents the magnetic field from escaping and/or upon the shielding device in such a way that a magnetic force assists the movement of the magnet into the release position.

If the magnetic gripper has the housing portion that prevents the magnetic field from escaping and/or the shielding device, the feature that the contact surface angle ranges in size from 170° to 190° and/or the feature that each workpiece contact surface defines a contact surface angle between itself and the displacement direction may be optional. In other words, if the magnetic gripper has the housing portion that prevents the magnetic field from escaping and/or the shielding device, the magnetic gripper may or may not have the feature that the contact surface angle ranges in size from 170° to 190° and/or the feature that each workpiece contact surface defines a contact surface angle between itself and the displacement direction.

A magnetic gripper system according to the invention has a previously described magnetic gripper and the ferromagnetic workpiece. In a gripping state, the magnet is in the gripping position, and the ferromagnetic workpiece is pressed against each workpiece contact surface by a magnetic force. In a release state, the magnet is in the release position, and the ferromagnetic workpiece is not pressed against any workpiece contact surface.

In the gripping position, the magnetic field of the magnet can be designed to apply to the ferromagnetic workpiece a magnetic force that is directed onto the workpiece contact surface and is preferably greater than a weight force of the ferromagnetic workpiece. This allows the workpiece to be pushed or pressed against the workpiece contact surface by means of the magnetic force.

In a further development of the magnetic gripper system, at least one of the projections has a length whose value deviates by a maximum of 25% from a value of a thickness of the workpiece. Advantageously, this can further reduce the depth effect for unstacking thin workpieces.

Further advantages and advantageous embodiments of the invention can be found in the figures, the description, and the claims. All features disclosed in the figures, their description, and the claims can be essential to the invention, both individually and in any combination with one another. In the drawings:

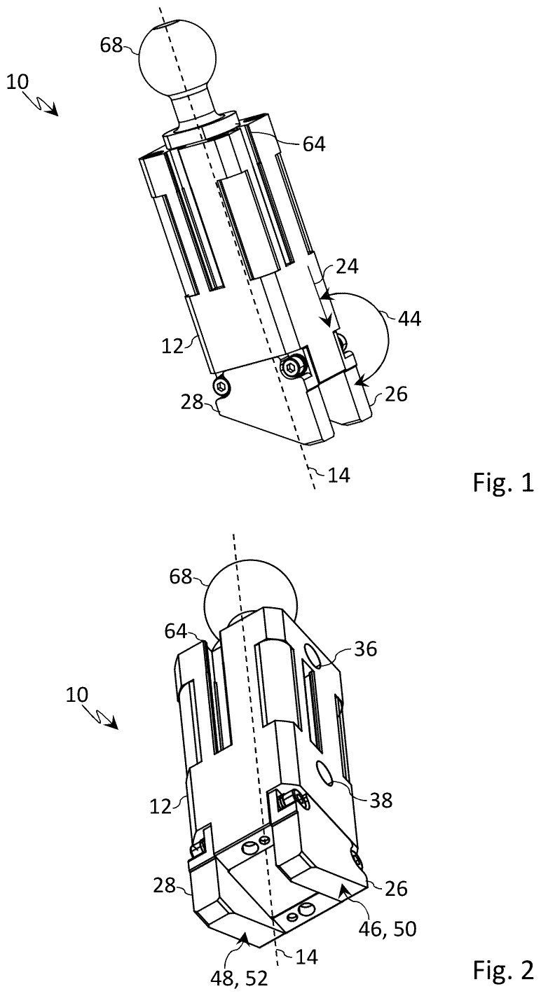

FIG. 1 is a schematic oblique view of a magnetic gripper,

FIG. 2 is a further schematic oblique view of the magnetic gripper,

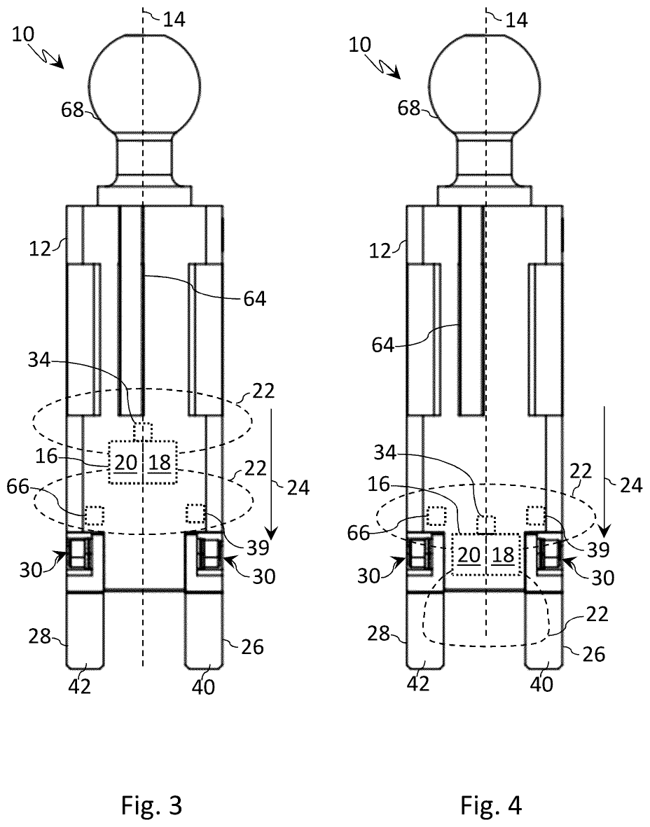

FIG. 3 is a schematic side view of the magnetic gripper having a magnet in a release state,

FIG. 4 is a schematic side view of the magnetic gripper with the magnet in a gripping position,

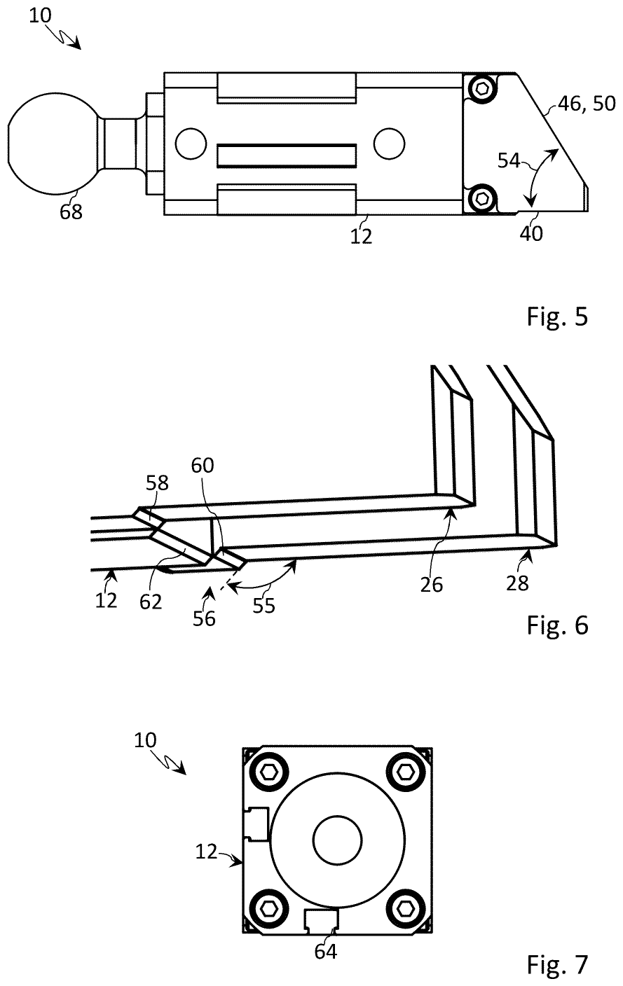

FIG. 5 is a further schematic side view of the magnetic gripper,

FIG. 6 is a schematic detail view of pole shoes of the magnetic gripper,

FIG. 7 is a schematic plan view of a manipulator interface of the magnetic gripper,

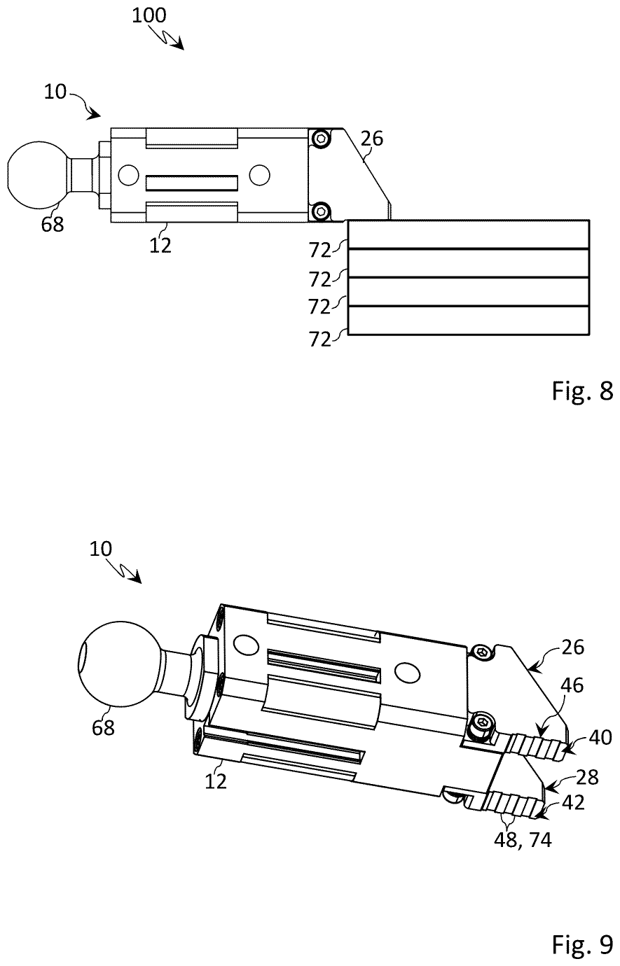

FIG. 8 is a schematic representation of the magnetic gripper during the final stacking of a metal sheet,

FIG. 9 is a schematic oblique view of a further exemplary embodiment of a magnetic gripper according to the invention,

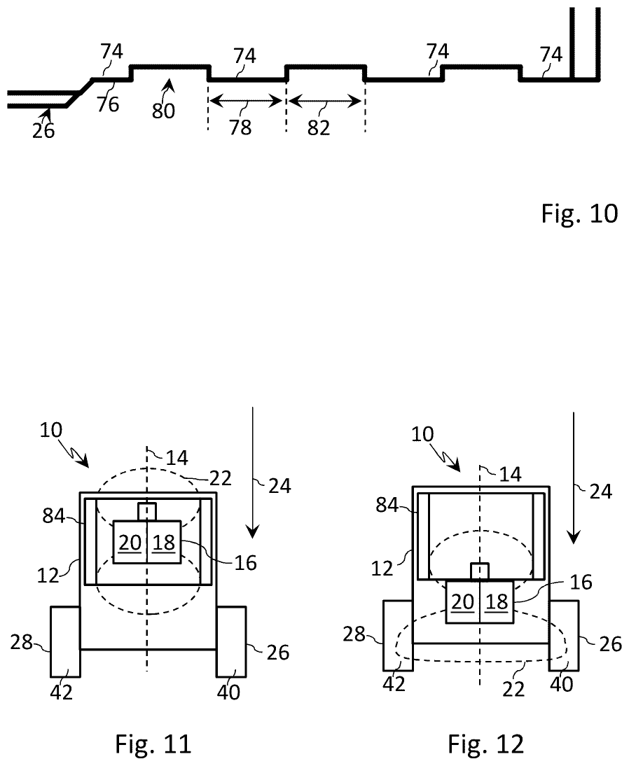

FIG. 10 is a schematic detail view of pole shoes of the magnetic gripper of FIG. 9,

FIG. 11 is a schematic representation of a further exemplary embodiment of a magnetic gripper according to the invention, and

FIG. 12 shows a further schematic representation of the magnetic gripper from FIG. 11.

FIGS. 1 to 4 show a magnetic gripper 10. The magnetic gripper 10 is designed for gripping a ferromagnetic workpiece.

The magnetic gripper 10 has a housing 12. The housing 12 is elongated. The housing 12 extends along a longitudinal axis 14. The housing 12 is not magnetizable. The housing 12 is made of aluminum.

The magnetic gripper 10 has a magnet 16, which is arranged in the housing 12. The magnet 16 is shown in dotted lines in FIGS. 3 and 4. The magnet 16 is a permanent magnet. The magnet 16 has a north pole 18 and a south pole 20. A magnetic field 22 of the magnet 16 extends from the north pole 18 to the south pole 20. The magnetic field 22 runs along magnetic field lines, which are shown in dashed lines in FIGS. 3 and 4. The magnet 16 is arranged in the housing 12 such that the north pole 18 and the south pole 20 are aligned orthogonally to the longitudinal axis 14.

The magnet 16 is displaceable in a straight displacement direction 24 between a gripping position and a release position. In the illustrated exemplary embodiment, the magnet is transferred from the release position to the gripping position by a movement along or in the direction of displacement 24 and from the gripping position to the release position by a movement opposite the displacement direction 24. The magnet 16 is shown in FIG. 3 in the release position and in FIG. 4 in the gripping position.

The magnetic gripper 10 has a first pole shoe 26 and a second pole shoe 28. Each pole shoe 26, 28 is formed in one piece. Each pole shoe 26, 28 is made of a ferromagnetic material. In the illustrated exemplary embodiment, the two pole shoes 26, 28 are made of iron. Each pole shoe 26, 28 is designed to guide a magnetic field portion of the magnetic field 22 to the workpiece for gripping the workpiece by means of the magnetic gripper 10.

The first pole shoe 26 and the second pole shoe 28 are arranged on opposite sides of the housing 12. The magnetic gripper 10 has a fastening device 30 which has four countersunk holes for fastening the two pole shoes 26, 28 to the housing 12. Two countersunk holes are formed in each pole shoe 26, 28.

The two pole shoes 26, 28 are each releasably fastened to the housing 12 by means of the fastening device 30. The fastening is produced by means of screws which are inserted into the counterbores and screwed into threaded holes of the fastening device 30 which are formed in the housing 12 and whose positions correspond to the positions of the counterbores. The screw connections thus produced allow the two pole shoes 26, 28 to be replaced. The fastening device 30 can have the screws by means of which the two pole shoes 26, 28 are fastened to the housing 12.

The displacement of the magnet 16 from the release position to the gripping position is effected by a displacement of the magnet 16 along the straight displacement direction 24 toward the two pole shoes 26, 28. The displacement of the magnet 16 from the gripping position to the release position is effected by displacement of the magnet 16 away from the two pole shoes 26, 28. As a result, in the release position, a smaller portion of the magnetic field 22 reaches the pole shoes 26, 28 than in the gripping position.

The linear displacement of the magnet 16 is effected by means of a pneumatic drive 34 of the magnetic gripper 10. The pneumatic drive 34 may include a piston connected to the magnet 16. The housing 12 has a first opening 36 and a second opening 38; see FIG. 2. Gas can be supplied through the two openings 36, 38 in order to move the piston and thus the magnet 16 between the release position and the gripping position. This allows the magnet 16 to be moved pneumatically. In an alternative exemplary embodiment (not shown), the magnet can be designed to be electrically or mechanically displaceable between the gripping position and the release position.

By supplying gas via the first opening 36 into a housing portion above the piston, the gas exerts pressure on an upper surface of the piston, thereby exerting a downward force on the piston and thus the magnet 16. In response, the piston and the magnet 16 move along the displacement direction 24 toward the pole shoes 26, 28 until the magnet 16 assumes the gripping position.

By supplying gas via the second opening 38 into a housing portion below the piston, the gas exerts pressure on a lower surface of the piston, thereby exerting an upward force on the piston and thus the magnet 16. In response, the piston and the magnet 16 move away from the pole shoes 26, 28 in the opposite direction to the displacement direction 24 until the magnet 16 assumes the release position.

The magnetic gripper 10 has a position sensor 39 for detecting whether the magnet 16 is in the gripping position or in the release position. The position sensor 39 is shown in dotted lines in FIGS. 3 and 4. The position sensor 39 is designed to detect the gripping position and the release position based upon a detection of the magnetic field 22. Thereby, the supply of gas via the first opening 36 can be interrupted when the position sensor 39 detects that the magnet 16 has assumed the gripping position, or the supply of gas via the second opening 38 can be interrupted when the position sensor 39 detects that the magnet 16 has assumed the release position.

FIG. 3 shows that the magnet 16 is not arranged between the two pole shoes 26, 28 in the release position.

The first pole shoe 26 has a workpiece contact surface 40, and the second pole shoe 28 has a workpiece contact surface 42. The two workpiece contact surfaces 40, 42 serve to contact a workpiece gripped by the magnetic gripper 10.

The two workpiece contact surfaces 40, 42 are each flat. The two workpiece contact surfaces 40, 42 are aligned parallel to one another. The two workpiece contact surfaces 40, 42 are aligned parallel to the longitudinal axis 14. The two workpiece contact surfaces 40, 42 and the displacement direction 24 define a contact surface angle 44 between them; see FIG. 1. The contact surface angle 44 is 180°. In other words, the workpiece contact surfaces 40, 42 are aligned parallel to the displacement direction 24.

The two workpiece contact surfaces 40, 42 are each formed as a single, uninterrupted surface. The two workpiece contact surfaces 40, 42 form a flat holding surface of the magnetic gripper 10. As a result, the magnetic gripper 10 is designed to grip workpieces in the form of flat metal sheets.

If workpieces having a different shape are to be gripped by means of the magnetic gripper 10, the two pole shoes 26, 28 can be replaced by other pole shoes whose workpiece contact surfaces follow the shape of the workpieces to be gripped.

Each pole shoe 26, 28 is designed to direct a magnetic field portion of the magnetic field 22 to its workpiece contact surface 40, 42. The first pole shoe 26 has an active structure 46 for directing the magnetic field portion to its workpiece contact surface 40, and the second pole shoe 26 has an active structure 48 for directing the magnetic field portion to its workpiece contact surface 42; see FIGS. 2 and 5. The active structure 46 of the first pole shoe 26 and the active structure 48 of the second pole shoe 28 are identical, in particular structurally identical.

The two active structures 46, 48 each have a bevel 50, 52. By means of the bevels 50, 52, the magnetic field portion guided in the pole shoes 26, 28 is directed onto the workpiece contact surfaces 40, 42, whereby the magnetic field portion at the workpiece contact surfaces 40, 42 is increased.

The bevel 50 of the first pole shoe 26 and the workpiece contact surface 40 of the first pole shoe 26 define a bevel angle 54 between them; see FIG. 5. The bevel 52 of the second pole shoe 28 and the workpiece contact surface 42 of the second pole shoe 28 define a bevel angle between them. The bevel angle 54 of the first pole shoe 26 and the bevel angle of the second pole shoe 28 are each 60°.

FIGS. 3 and 4 show that the magnet 16 is arranged in the housing such that, in the gripping position, the first pole shoe 26 acts as the north pole and the second pole shoe 28 acts as the south pole.

In the gripping position, a magnetic field portion of the magnetic field 22 is directed to the workpiece contact surfaces 40, 42, which field, if a workpiece is arranged on the workpiece contact surfaces 40, 42, exerts a magnetic force on the workpiece. The magnetic force is directed toward the workpiece contact surfaces 40, 42, so that the workpiece is pushed, in particular pressed, against the workpiece contact surfaces 40, 42 by means of the magnetic force. If the magnetic force is greater than a weight force of the workpiece, the workpiece can be gripped by the magnetic gripper 10, and the magnetic gripper 10 can lift the workpiece.

In the release position, no magnetic field portion is directed to the workpiece contact surfaces 40, 42. Alternatively, a magnetic field portion of the magnetic field 22 can be directed to the workpiece contact surfaces 40, 42, which, if a workpiece is arranged on the workpiece contact surfaces 40, 42, does not cause a magnetic force on the workpiece that is greater than a weight force of the workpiece. This allows the workpiece to be released from the magnetic gripper 10. The workpiece cannot be gripped by the magnetic gripper 10.

The magnetic gripper 10 has a positioning device 56; see FIG. 6. The positioning device 56 serves to position a workpiece relative to the magnetic gripper 10. The positioning device 56 is adjacent to the workpiece contact surfaces 40, 42. The positioning device 56 is a guide in the form of a sliding surface, which is designed to guide a workpiece to the workpiece contact surfaces 40, 42. The sliding surface and the workpiece contact surfaces 40, 42 define a sliding surface angle 55 between them. The sliding surface angle 55 is 130°. The sliding surface angle 55 can range in size from 110° to 160°. As a result, a workpiece slides along the sliding surface while the workpiece is guided to the two workpiece contact surfaces 40, 42 by means of the positioning device 56, until the workpiece lies flat against the workpiece contact surfaces 40, 42.

In the illustrated exemplary embodiment, the positioning device 56, in particular the sliding surface, is formed from three surface portions 58, 60, 62. The three surface portions 58, 60, 62 are aligned parallel to one another. The first surface portion 58 is formed by the first pole shoe 26. The second surface portion 60 is formed by the second pole shoe 28. The third surface portion 62 is formed by the housing 12.

The first surface portion 58 borders the workpiece contact surface 40 of the first pole shoe 26. The second surface portion 60 borders the workpiece contact surface 42 of the second pole shoe 28.

The housing 12 has a receptacle 64 in the form of a groove for receiving a supply line; see in particular FIG. 7. By means of the groove 64, at least one supply line, e.g., a power line, can be positioned in a defined position or arranged and/or fastened in the defined position on the housing 12, which is why the supply line does not hinder the gripping of a workpiece with the magnetic gripper 10. The groove 64 has a T-shaped cross-section.

The magnetic gripper 10 has a workpiece sensor 66 for detecting a workpiece. The workpiece sensor 66 is shown in dotted lines in FIGS. 3 and 4. By means of the workpiece sensor 66, it can be detected whether a workpiece is correctly arranged on the workpiece contact surfaces 40, 42 or not.

The magnetic gripper 10 has a manipulator interface 68 for attaching the magnetic gripper 10 to a manipulator-for example, to a robot arm. The manipulator interface 68 is attached to the housing 12, in particular by means of a screw connection. The manipulator interface 68 and the pole shoes 26, 28 are arranged on opposite sides of the housing 12.

The manipulator interface 68 is spherical, so as to form a ball joint. The manipulator may have a receptacle for accommodating the spherical manipulator interface 68. When the manipulator interface 68 is inserted into the manipulator receptacle, a ball joint is formed.

FIG. 8 shows a stack of several workpieces 72. The several workpieces 72 are arranged one above the other, in particular stacked.

Each workpiece 72 is made of iron. Each workpiece 72 is a metal sheet. A width and a length of each workpiece 72 are more than five times a thickness of the workpiece 72.

The magnetic gripper 10 is intended to grip the uppermost workpiece 72 from the stack of several workpieces 72 without gripping the remaining workpieces 72.

The magnetic gripper 10 and the gripped uppermost workpiece 72 form a magnetic gripper system 100. In a gripping state, the magnet 16 is in the gripping position, and the workpiece 72 is pressed against the two workpiece contact surfaces 40, 42 by means of the magnetic force. In a release state, the magnet 16 is in the release position, and the workpiece 72 is not pressed against the workpiece contact surfaces 40, 42 by the magnetic force.

To grip the workpiece 72, the magnet 16 is moved into the release position, and the magnetic gripper 10 is placed relative to the uppermost workpiece 72 so that the uppermost workpiece 72 is in the vicinity of the workpiece contact surfaces 40, 42. The magnet 16 is then moved into the gripping position so that the magnetic field portion of the magnetic field 22 guided by the two pole shoes 26, 28 is a portion of the magnetic field 22 required for gripping the workpiece 72.

Through the active structures 46, 48, the magnetic field portion of the magnetic field 22 is guided to the workpiece contact surfaces 40, 42 in such a way that a magnetic force acts upon the stack of several workpieces 72. The magnetic force is suitable only for gripping the top workpiece 72. In other words, the magnetic force acting upon the top workpiece 72 is greater than the weight force of the top workpiece 72. The magnetic force acting upon the workpiece 72 located immediately below the uppermost workpiece 72 is not sufficient to grip this workpiece 72.

The magnetic force presses the uppermost workpiece 72 against the positioning device 56, and the workpiece 72 slides along the positioning device 56, until the workpiece 72 makes full contact with the workpiece contact surfaces 40, 42. The magnetic force presses the workpiece 72 against the workpiece contact surfaces 40, 42.

FIGS. 9 and 10 show a further exemplary embodiment of the magnetic gripper 10 of FIGS. 1 to 8, wherein the same reference signs are used for identical and functionally equivalent elements, and, in this respect, reference can be made to the above explanations regarding the exemplary embodiment of FIGS. 1 to 8, such that, essentially, only the existing differences will be discussed.

The two workpiece contact surfaces 40, 42 are each a surface composed of several separate surface portions. In other words, the workpiece contact surfaces 40, 42 are not contiguous surfaces.

Each active structure 46, 48 has four projections 74 for directing the magnetic field portion and for forming the workpiece contact surface 40, 42. FIG. 10 shows the projections 74 of the first pole shoe 26 in an enlarged lateral view. Each projection 74 has a free end 76 which partially forms the workpiece contact surface 40.

Three of the four projections 74 have the same length 78. As a result, three of the four projections 74 are of equal length. Two adjacent projections 74 are separated from one another by means of a recess 80. All recesses 80 have the same length 82. The length 82 of each recess 80 and the length 78 of each of the three of the four projections 74 are equal in size.

FIGS. 11 and 12 show a further exemplary embodiment of the magnetic gripper 10 of FIGS. 1 to 8, wherein the same reference signs are used for identical and functionally equivalent elements, and, in this respect, reference can be made to the above explanations regarding the exemplary embodiment of FIGS. 1 to 8, such that, essentially, only the existing differences will be discussed.

The magnetic gripper 10 has a shielding device 84. The shielding device 84 is designed to prevent the magnetic field 22 of the magnet 16 from escaping laterally from the housing 12, at least when the magnet 16 is in the release position. The shielding device 84 is made of iron. The shielding device 84 is hollow-cylindrical in shape.

FIG. 11 shows the magnet 16 in the release position. In the release position, the magnet 16 is arranged in an interior of the hollow-cylindrical shielding device 84. This prevents the magnetic field 22 from escaping laterally from the housing 12.

FIG. 12 shows the magnet 16 in the gripping position. In the gripping position, the magnet 16 is arranged outside the interior of the hollow-cylindrical shielding device 84. The magnetic field 22 is directed to the workpiece contact surfaces 40, 42 by the two pole shoes 26, 28.

1. A magnetic gripper for gripping a ferromagnetic workpiece, said magnetic gripper comprising:
a housing,
a magnet which is arranged in the housing and which is displaceable along a displacement direction between a gripping position for gripping the ferromagnetic workpiece and a release position for releasing the ferromagnetic workpiece, and
a number of pole shoes attached to the housing, wherein
each pole shoe has a workpiece contact surface and is designed to guide a magnetic field portion of the magnet to the workpiece contact surface,
the workpiece contact surface defines a contact surface angle between the workpiece contact surface and the displacement direction, and
the contact surface angle ranges in size from 170° to 190°.

2. The magnetic gripper according to claim 1, wherein
the housing extends along a longitudinal axis,
the displacement direction is aligned parallel to the longitudinal axis of the housing.

3. The magnetic gripper according to claim 1, wherein
each pole shoe has an active structure for directing the magnetic field portion.

4. The magnetic gripper according to claim 3, wherein
the active structure has a bevel,
the bevel and the workpiece contact surface define a bevel angle between the bevel and the workpiece contact surface, and
the bevel angle ranges in size from 5° to 85° or, in 15° to 75° or, preferably 40° to 60°.

5. The magnetic gripper according to claim 3, wherein
the active structure has a plurality of projections for directing the magnetic field portion and for forming the workpiece contact surface.

6. The magnetic gripper according to claim 5, wherein
the plurality of projections include at least a first projection and a second projection,
the first projection and the second projection are adjacent to one another,
the active structure has a recess between the first projection and the second projection, and
a depth and/or a length of the recess has a value that deviates by at most 25% from a value of a length of the first projection and/or a value of a length of the second projection.

7. The magnetic gripper (10) according to claim 1, wherein
the magnetic gripper (10) has a positioning device (56) for positioning the ferromagnetic workpiece (72) on the workpiece contact surface (40, 42).

8. The magnetic gripper according to claim 1, wherein
the number of pole shoes includes a first pole shoe and a second pole shoe, and
the magnet is arranged in the housing such that, in the gripping position, the first pole shoe acts as a north pole and the second pole shoe acts as a south pole.

9. The magnetic gripper according to claim 1, wherein
the magnet is displaceable electrically, pneumatically, or mechanically between the gripping position and the release position.

10. The magnetic gripper according to claim 1, wherein
the magnetic gripper has a position sensor for detecting the gripping position and/or the release position, and/or
the magnetic gripper has a workpiece sensor for detecting the ferromagnetic workpiece.

11. The magnetic gripper according to one of claim 1, wherein
the housing has a receptacle for receiving a workpiece sensor and/or a supply line.

12. The magnetic gripper according to claim 1, wherein
the magnetic gripper has a manipulator interface for attaching the magnetic gripper to a manipulator.

13. The magnetic gripper according to claim 1, wherein
a housing portion of the housing is designed to largely suppress the escape of the magnetic field of the magnet from the housing portion, or
the magnetic gripper has a shielding device which is designed to at least partially prevent the magnetic field of the magnet from escaping the housing.

14. A magnetic gripper system, the magnetic gripper system comprising:
a magnetic gripper according to claim 5, and
the ferromagnetic workpiece,
wherein, in a gripping state, the magnet is in the gripping position, and the ferromagnetic workpiece is pressed against each workpiece contact surface by means of a magnetic force, and
wherein, in a release state, the magnet is in the release position and the ferromagnetic workpiece is not pressed, by means of a magnetic force, against each workpiece contact surface.

15. The magnetic gripper system according to claim 14, wherein
at least one of the projections has a length whose value deviates by at most 25% from a value of a thickness of the ferromagnetic workpiece.

16. The magnetic gripper according to claim 1, wherein
the receptacle is in the form of a groove.
